(19) United States
(12) Patent Application Publication
(10) Pub. No.: US 2025/0338871 A1
(43) Pub. Date: Nov. 6, 2025

(54) LEGUMINOUS PROTEIN EXTRACT HAVING IMPROVED ACID-GELLING PROPERTIES

(71) Applicant: ROQUETTE FRERES, LESTREM (FR)

(72) Inventor: Jennifer Louise KIMMEL, NILES, IL (US)

(21) Appl. No.: 19/132,678

(22) PCT Filed: Nov. 28, 2023
(86) PCT No.: PCT/EP2023/083435

§ 371 Date: May 23, 2025

Related U.S. Application Data
(60) Provisional application No. 63/428,209, filed on Nov. 28, 2022.

(30) Foreign Application Priority Data
Nov. 30, 2022 (EP) 22306760.4

(51) Int. Cl. A23J 3/14; A23C 11/10; A23J 1/14; A23L 2/66

(52) U.S. Cl. CPC A23J 3/14; A23C 11/106; A23J 1/14; A23L 2/66

(57) ABSTRACT

The invention relates to a leguminous acid-gelling protein extract having a protein content, expressed on dry weight basis of the extract, of 75% or higher and a storage modulus of at least 1800 Pa, advantageously at least 2000 Pa when determined using TEST A, preferably at least 2500 Pa. The invention also relates to its method of preparation and its use in acid-gelling food products.

### TECHNICAL FIELD

The invention concerns a leguminous protein extract which has improved acid-gelling abilities.

### PRIOR ART

Daily human protein requirements are between 12 and 20% of the food ration. These proteins are supplied both by products of animal origin (meat, fish, eggs, dairy products) and vegetable origin (cereals, legumes, algae).

However, in industrialized countries, protein intake is mainly in the form of protein of animal origin. Numerous studies show that excessive consumption of proteins of animal origin to the detriment of vegetable proteins is one of the causes of increase in cancers and cardiovascular diseases.

In addition, animal proteins have many disadvantages, both in terms of their allergenicity, particularly concerning proteins from milk or eggs, and in environmental terms in relation to the harmful effects of intensive farming.

In a general manner, the use of vegetal proteins instead of animal protein has a favorable impact on the environment. Indeed, as final products are concerned, the use of vegetal proteins allows to use less energy and to generate much less greenhouse gas emissions.

Thus, there is a growing demand from manufacturers for ingredients of plant origin having advantageous nutritional and functional properties without, however, having the drawbacks of ingredients of animal origin.

Plants can be for example oleaginous plants such as soy, cereals such as oat. Different classes of plant exist and the protein of each plant will comprise different kind of proteins, proportions and properties. In other words, proteins extracted from oat (such as the ones described in WO2022/144452 A1) or soy proteins will be very different from leguminous proteins such as pea, fava bean or mung bean.

Since the 1970s, interest in leguminous proteins has grown strongly, as an alternative protein resource to animal proteins intended for animal and human food. For example, pea contains about 27% by weight of protein content. Pea proteins, mainly pea globulin proteins, have been extracted and industrially valued for many years now.

However, compared to animal proteins, leguminous proteins are known to have less gelling properties than animal proteins such as the ones extracted from animal milk or eggs.

These protein compositions can be mixed in various food compositions. Food compositions can present very different pH, ranging from 3 to 9. There is an application field where high gelling properties have strong interest: the field of acid-gelling food products. By “acid-gelling food product”, it is meant an acidic food which develops gelling properties during acidification. Acid-gelling food products include for example yogurts, cheeses and acidic sauces (mayonnaise, ketchup, etc. . . . ). On the opposite of thermal gelling proteins, it is important that the acid gelling proteins are able to form a gel, when they are put in acidic conditions.

To manufacture an acidic set or stirred yogurt starting from a protein milk, it is needed that the yogurt increases viscosity and forms a gel during the acidification by fermentation using microorganisms. In that sense, the phenomenon of acid-gelling is very different from the phenomenon of thermal gelling, i.e. the phenomenon of protein gelling induced by a thermal treatment. In the case of yogurt, to maintain the benefit of the probiotics present in a fermented product, it is important that no thermal treatment occurs at the end of the process, after the formation of the gel. The manufacture of fermented acid gelling foods such as yogurts, generally comprise a step of manufacturing a milk or milk substitute, a pasteurization step of this milk followed by its fermentation. Because of the pasteurization which is mandatory for food safety reasons, it is also important that the proteins in the milk substitute are able to be heat treated without being fully gelled before the fermentation step. When manufacturing yogurts, the gelling properties of the proteins are developed during acidification of the yogurt, this acidification being caused by the use of probiotic microorganisms. The decrease of pH induces the precipitation of the proteins and their aggregation. The consequent microstructure determines the texture and the high viscosity of the resulting gelled yogurt product.

However, leguminous proteins and especially pea proteins are generally considered as having weaker acid-gelling properties than animal milk proteins, which consist mainly in a blend of whey and casein. Therefore, the low acid-gelling properties of the leguminous proteins, especially pea proteins, cause issues when manufacturing acid-gelling food products. It is thus important to provide new leguminous protein compositions having higher acid-gelling properties than the pea protein alone in order to facilitate the manufacture of the acid-gelling food products.

To provide vegetable-based acid-gelling food products having improved texture and viscosity, it has been proposed to use, in combination of ingredients comprising proteins, additives to mimic the gel to the acid-gelling foods. Such gelling additives include gums such as xanthan gums, or pectins such as low-methoxy pectins which are generally prepared from ‘waste’ citrus peel and apple pomace. However, these additives are not fully satisfactory in terms of nutritional benefits and some of these products are generally not considered as “clean-label” additives. Another solution is to use in combination with the protein, a pregelatinized starch: the viscosity and gel texture is then provided by the pregelatinized starch that presents some gel properties at acidic pH.

For example, in the field of acidic sauces, WO2014/001030 describes an emulsion, such as a mayonnaise sauce, that comprises pulse albumin in the form of finely grinded flour, pregelatinized starch and xanthan gum or pectins. Another solution to provide such kind of mayonnaise sauce is described in WO2021/219967, which describes the use of a blend of leguminous albumins and pregelatinized starch to manufacture vegan mayonnaise sauce.

In the field of yogurts, the need of acid-gelling properties is also important and WO2017/185093 describes different recipes of yogurts obtained from the fermentation of a milk comprising pea protein. Similarly, document WO2019/069111 also describes a process that uses a step of heating of a pea protein milk before inoculating the obtained mixture with lactic acid bacteria in order to provide a non-dairy fermented food product, having substantially no added stabilizers, with a determined viscosity and firmness. The processes described above need specific conditions and, moreover, most of the time, when using the pea proteins of the market, the described processes do not allow to reach the properties desired for the yogurt, and low gelling properties can still be observed, especially when the protein content of the yogurt is low.

Patent application WO2022/248601 A1 (unpublished patent application at the date of priority of the present application) describes the improvement of acid gelling properties of a leguminous proteins adding cooked leguminous fiber. However, the process of manufacturing to obtain the leguminous protein composition requires an extra step of cooking the leguminous fiber and a step of blending, which leads to a leguminous protein composition that comprises certain amounts of gelatinized starch. The addition of the cooked leguminous fiber will also decrease the protein content of the leguminous protein composition, which can be an issue for some applications where protein content has to be high. The document does not describe a leguminous protein extract with improved acid-gelling properties but a composition comprising leguminous protein extract and a cooked fiber ingredient. Moreover, the acid-gelling properties of this composition could be even more improved (see below in the description).

WO2022/187285 A1 describes a method of purifying proteins to help reduce colors, odors and flavors using a process including the precipitation of proteins in an organic solvent. US2022022490 A1 discloses pea protein isolates having low content of sodium and especially useful for food extrusion process. Both documents are fully silent regarding acid-gelling properties of the obtained proteins.

It appears from the above that it would be helpful to provide leguminous protein compositions able to have high acid-gelling properties, in order to facilitate the manufacture of acid-gelling foods based on leguminous proteins and/or without needing the addition of gelling additives.

### DESCRIPTION OF THE INVENTION

It is one of the achievements of the invention to provide a new leguminous protein extract displaying improved acid-gelling abilities, notably an improved gel strength and/or gel firmness. Indeed, during their investigations, the inventors have surprisingly observed that it was possible to improve the acid-gelling ability of a leguminous protein by subjecting it to a thermal treatment under specific conditions, notably under specific alkaline conditions.

Thus, unexpectedly, the obtained acid-gelling leguminous protein displays an improved storage modulus, as well as an improved firmness, rendering it particularly advantageous for preparing acid-gelling food products.

In a first aspect, the invention provides a leguminous acid-gelling protein extract having a protein content, expressed on dry weight basis of the extract, of 75% or higher and a storage modulus of at least 1800 Pa, advantageously at least 2000 Pa when determined using TEST A, preferably at least 2500 Pa. According to the invention, an “acid-gelling protein” means that it presents the above storage modulus of at least 1800 Pa when determined using TEST A.

As shown in the Examples section, the acid-gelling properties using the TEST A are determined in the form of a slurry having 5% of dry matter. This choice of 5% of dry matter instead of 15% (as used in the patent application WO2022/248601 A1 or WO2022/144452 A1) is related to the much higher acid-gelling properties of the leguminous protein extract of the invention, so that the G′ values of the invention with this TEST A cannot be directly compared with the ones indicated in these documents. Indeed, if using 15% instead of 5% of dry matter, the samples of the invention tested may become extremely thick so that it could give an inaccurate measurements and inadequate comparisons. It has to be noted further that regular yogurts comprise a protein content much closer to 5% than 15%. The protein extract of the invention is fully adapted to all kind of yogurts including regular yogurts. WO2022/144452 A1 indicates that some processes may slightly improve acid-gelling properties of oat proteins when tested in a 15% dry matter suspension. This does not suggest that it would be possible to improve acid-gelling of leguminous proteins instead of oat with these processes. And, even more, it would never suggest the possibility to reach the storage modulus of the invention with a suspension comprising only 5% of dry matter of the protein extract, which is close to the protein content of regular yogurt.

In some embodiments, the leguminous acid-gelling protein extract of the invention has/comprises the following additional features:
the leguminous acid-gelling protein extract has a firmness of at least 100 g when determined using TEST B, advantageously at least 125 g, preferably at least 150 g;
the leguminous acid-gelling protein extract comprises sodium Na and potassium K in a molar ratio (Na/K) ranging from 10:90 to 90:10;
the leguminous acid-gelling protein extract comprises, based on the total dry mass of the extract, a total content of sodium Na and potassium K ranging from 10000 to 50000 ppm, for example from 15000 to 40000 ppm, preferably from 18000 to 30000 ppm;
the leguminous acid-gelling protein extract is a pea acid-gelling protein extract;
the leguminous acid-gelling protein extract wherein the protein is denaturated;
the leguminous acid-gelling protein extract has a pH which ranges from 8.0 to 9.5;
the leguminous acid-gelling protein extract has a pH which ranges from 5.0 to 8.0, for example from 6.0 to 8.0;
the leguminous acid-gelling protein extract has a dry matter ranging from 90 to 100%.

In a second aspect, the invention provides a method of preparation of an acid-gelling leguminous protein extract according to the invention, comprising the following steps:
i) preparing an aqueous solution of a leguminous protein extract;
ii) adjusting the pH of the solution of step i) to a value comprised in the range of from 8.0 to 9.5;
iii) heating the solution of step ii) at a temperature ranging from 80° C. to 160° C. during a time sufficient to increase the storage modulus of the leguminous protein extract;
iv) optionally adjusting the pH of the solution of step iii) to a value comprised in the range of from 5.0 to 8.0;
v) recovering the obtained acid-gelling leguminous protein extract; and
vi) optionally drying the obtained acid-gelling protein extract.

In a third aspect, the invention provides a use of the leguminous acid-gelling protein extract of the invention in acid-gelling food products.

In some embodiments, the method of preparation acid-gelling leguminous protein extract according to the invention has/comprises the following additional features:
the leguminous protein extract provided in step i) is prepared by a process comprising the steps of:
   providing leguminous plant seeds containing a leguminous protein;
   milling said leguminous plant seeds and suspending the obtained flour in an extracting liquid;
   recovering the leguminous protein from the suspension, thereby obtaining a protein leguminous extract.
the time of the heating step iii) ranges from 0.1 second to 10 minutes, preferably from 0.1 s to 1 minute, most preferably from 0.5 s to 50 s, for example from 1 s to 40 s or 2 s to 30 s or 5 to 20 s;
the temperature during the heating step iii) ranges from 120 to 150° C.;
the heating step iii) is performed during a sufficient time to reach a storage modulus of at least 1800 Pa;
step ii) is performed by adding to the solution of step i), a mixture of sodium hydroxide and potassium hydroxide, preferably in a (NaOH/KOH) molar ratio ranging from 10:90 to 90:10.

In a fourth aspect, the invention provides an acid-gelling food products comprising a leguminous acid-gelling protein extract of the invention.

In a further aspect, the invention provides an acid-gelling leguminous protein extract obtainable by the process of the invention.

### DESCRIPTION OF THE FIGURE

FIG. 1 represents the evolution of the pH of cultured yogurt bases vs fermentation time.

FIG. 2 represents the sensory evaluation of thickness for three different proteins in suspension: PURIS® P875 pea protein, EMPRO® E86 HV pea protein and the leguminous protein extract of the invention.

FIG. 3 represents the sensory evaluation of creaminess for three different proteins in suspension: PURIS® P875 pea protein, EMPRO® E86 HV pea protein and the leguminous protein extract of the invention.

FIG. 4 represents the sensory evaluation of mouthcoating for three different proteins in suspension: PURIS® P875 pea protein, EMPRO® E86 HV pea protein and the leguminous protein extract of the invention.

FIG. 5 represents the sensory evaluation of different texture attributes of three powder mix beverages, one comprising PURIS® P875 pea protein, one comprising PISANE® C9 pea protein and one comprising the leguminous protein extract of the invention.

FIG. 6 represents the sensory evaluation of different texture attributes of two powder mix beverages, one comprising NUTRALYS® S85F pea protein, and one comprising the leguminous protein extract of the invention.

### DETAILED DESCRIPTION OF THE INVENTION

### Leguminous Acid-Gelling Protein Extract

A first aspect of the invention relates to a leguminous acid-gelling protein extract having a protein content, expressed on dry weight basis of the extract, of 75% or higher and a storage modulus of at least 1800 Pa, advantageously at least 2000 Pa when determined using TEST A, preferably at least 2500 Pa.

By “leguminous protein” it is meant a protein extracted from a leguminous plant.

For the purposes of the present invention, the term “leguminous plants” means any plants belonging to the family Cesalpiniaceae, the family Mimosaceae or the family Papilionaceae, and in particular any plants belonging to the family Papilionaceae. It can be for instance pea, fava bean, mung bean, lentil, alfalfa, or lupin bean. Preferably, said leguminous plant is chosen from the group consisting of pea, fava bean and mung bean. Even more preferably, said leguminous plant is pea.

The term “protein” as used in the present disclosure, refers to large biomolecules, or macromolecules, consisting of one or more long chains of amino acid residues. Like all leguminous-plant proteins, pea proteins consist of three main classes of proteins: globulins, albumins and “insoluble” proteins. In a preferred embodiment, the pea protein comprises mainly pea globulins, i.e. pea globulins are the major protein. Generally, the pea protein comprises at least 50% of pea globulins based on the dry weight of the total pea protein, preferably at least 75%.

According to the present invention, the protein extract may be a protein isolate or a protein concentrate, preferably a protein isolate. As an example, the pea protein extract may be a pea protein isolate or a pea protein concentrate. Protein isolates have generally a richness of at least 80%, e.g. from 80% to 95%, whereas protein concentrates have generally a richness going from 50% to 80%. The protein extract useful for the invention can be a protein concentrate having a richness ranging from 75% to 80%. The percentage by weight of protein N6.25 (i.e. richness) can be determined using the DUMAS method according to standard ISO 16634.

As used herein, the expression “storage modulus” refers to the gel strength and may be determined by using the test A, defined hereafter in the Example section. The ratio between the storage modulus (G′) of the alkaline heat-treated protein extract of the invention and the storage modulus (G′) of the neutral pH heat treated protein extract corresponds to the “gel strength ratio”. It therefore reflects the improvement of the gel strength (or storage modulus) of the protein extract which is obtained by heat treating the protein extract under alkaline conditions compared to the same protein extract subjected to the same process of the invention except that the heat treatment step is performed under neutral conditions (pH=7.0) instead of alkaline conditions.

In a preferred embodiment, the leguminous acid-gelling protein has a firmness of at least 100 g when determined using TEST B, advantageously at least 125 g, preferably at least 150 g.

As used herein, the term “firmness” refers to a textural parameter of the acid-gelling protein extract and is calculated from the peak force during compression of the acid-gelling protein extract in a compression assay, such as that disclosed in the TEST B provided in the Example section. The ratio between the firmness of the alkaline heat-treated protein extract of the invention and the firmness of the neutral pH heat treated protein extract corresponds to the “firmness ratio”. It therefore reflects the improvement of the firmness which is obtained by heat treating the protein extract under alkaline conditions compared to the same protein extract subjected to the exactly the same process of the invention except that the heat treatment step is performed under neutral conditions (pH=7.0) instead of alkaline conditions.

By “acid-gelling protein extract”, it is meant a protein extract that has high gelling properties when put at acidic pH, in particular having a storage modulus of at least 1800 Pa when determined using the TEST A and/or a gel firmness of at least 100 g when determined using the TEST B.

In some embodiments, the leguminous acid-gelling protein extract comprises sodium Na and potassium K in a molar ratio (Na/K) ranging from 10:90 to 90:10, most preferably ranging from 40:60 to 60:40.

In some embodiments, the leguminous acid-gelling protein extract comprises, based on the total dry mass of the extract, a total content of sodium Na and potassium K ranging from 10000 to 50000 ppm, for example from 15000 to 40000 ppm, preferably from 18000 to 30000 ppm. The molar ratios (Na/K) of these leguminous acid-gelling protein extracts can be such as described above.

Sodium and potassium quantification is well known to the man skilled in chemistry and biochemistry field, and he will know all suitable analytical methods that allow quantifying sodium and potassium content. In the context of the present disclosure, the use of flame absorption spectrometer is preferred.

In a preferred embodiment, the leguminous acid-gelling protein extract is a pea acid-gelling protein extract.

According to the invention, the term “pea” is herein considered in its broadest accepted sense and includes in particular:
all varieties of “smooth pea” and of “wrinkled pea”, and
all mutant varieties of “smooth pea” and of “wrinkled pea”, this being whatever the uses for which said varieties are generally intended (food for human consumption, animal feed and/or other uses).

In the present disclosure, the term “pea” includes the varieties of pea belonging to the Pisum genus and more particularly Pisum sativum.

Said mutant varieties are in particular those known as “r mutants”, “rb mutants”, “rug 3 mutants”, “rug 4 mutants”, “rug 5 mutants” and “lam mutants” as described in the article by C-L HEYDLEY et al. entitled “Developing novel pea starches”, Proceedings of the Symposium of the Industrial Biochemistry and Biotechnology Group of the Biochemical Society, 1996, pp. 77-87.

In a preferred embodiment, the pea is derived from smooth pea, in particular yellow smooth pea.

The pea protein generally presents a richness of at least 75%. The richness is according to the present disclosure the percentage by weight of protein N6.25 based on the total dry weight of the pea protein. Advantageously, the richness of the pea protein is at least 80%, preferably of at least 85%.

In another preferred embodiment, the protein contained in the leguminous acid-gelling protein extract is denaturated, notably by performing a heat treatment under basic conditions, more specifically under a pH comprised in the range of from 8 to 9.5, for a sufficient time to obtain an increase of the gel strength or gel firmness. Denaturation of the protein can be assessed by any suitable method, such as differential scanning calorimetry (DSC). The determination can be done using DSC by heating a sample of the leguminous acid-gelling protein extract at a heating rate of 10° C./min. One method is described in the examples section. Preferably, the denaturation enthalpy is lower than 0.1 J/g, preferably lower than 0.05 J/g, most preferably is equal to 0 J/g.

Preferably, the protein contained in the leguminous acid-gelling protein extract is not hydrolyzed. Preferably, the leguminous acid-gelling protein extract has a degree of hydrolysis below 6, for example between 3 and 5.5. The degree of hydrolysis of a protein is representative of the length of the amino-acids chains in the protein. The DH is known by the skilled person in the art and different methods exist to determine it. The degree of hydrolysis DH can be determined using the following equation:

$$DH = \frac{Amino nitrogen ( \% ) \times 100}{Protein nitrogen ( \% )}$$

in which the protein nitrogen is determined according to the DUMAS method according to standard ISO 16634 and amino nitrogen is determined using the MEGAZYME kit (reference K-PANOPA).

In one embodiment, the leguminous acid-gelling protein extract has a pH which ranges from 8.0 to 9.5, for example from 8.5 to 9.4.

In another embodiment, the leguminous acid-gelling protein extract has a pH which ranges from 5.0 to 8.0, for example from 6.0 to 8.0.

The pH of the acid-gelling leguminous extract can be made by determination of the pH at room temperature of a protein aqueous suspension prepared from the acid-gelling protein extract, this suspension having a dry matter of 5% or 10%. In the range going from 5% to 10%, the pH is going to be considered equivalent whatever the dry matter. The pH can be determined as indicated in the Examples section.

Preferably, the leguminous acid-gelling protein extract of the invention has a dry matter ranging from 90 to 100%.

The process will be described into details below. One of the advantages is that it does not need the use of any organic solvent so it is clear that one embodiment of the invention is that the leguminous acid-gelling protein extract is free from organic solvent. The leguminous acid-gelling protein extract can also be free of gelatinized starch.

### Method of Preparation of an Acid-Gelling Protein Extract

A second aspect of the present invention provides a method of preparation of an acid-gelling leguminous protein extract as defined above, comprising the following steps:
i) preparing an aqueous solution of a leguminous protein extract;
ii) adjusting the pH of the solution of step i) to a value comprised in the range of from 8.0 to 9.5;
iii) heating the solution of step ii) at a temperature ranging from 80° C. to 160° C. during a time sufficient to increase the storage modulus of the leguminous protein extract;
iv) optionally adjusting the pH of the solution of step iii) to a value comprised in the range of from 5.0 to 8.0;
v) recovering the obtained acid-gelling leguminous protein extract; and
vi) optionally drying the obtained acid-gelling protein extract.

### Step i)

In step i), an aqueous solution of a leguminous protein extract is prepared. The solid content of the aqueous solution may be comprised in the range of from 5 to 20%, notably of from 10 to 15%.

The leguminous protein extract implemented in step i) may be obtained from the corresponding leguminous plant seeds, notably according to a process comprising the steps of:
providing leguminous plant seeds containing a leguminous protein;
milling said leguminous plant seeds and suspending the obtained flour in a liquid, in particular in an aqueous solution;
recovering the leguminous protein from the suspension, thereby obtaining a protein leguminous extract.

The milling step may be performed according to well-known methods, notably according to a dry or wet process. Dry process generally comprises a step of milling leguminous plant seeds to form a leguminous flour and at least one step of fractionation of the flour, generally by air classification or by sieving, the finer fraction obtained being richer in protein. Generally, the wet process to obtain a leguminous protein comprises a step of providing a suspension of flour in water, at least one step of separation to remove insoluble starch and fiber from the suspension to obtain a soluble protein-rich liquid fraction and a step of isolation of the leguminous proteins. The suspension of flour can be obtained by dry grinding or wet grinding of the leguminous plant seeds. The separation step can be done using separation devices such as hydrocyclones, decanters, centrifugators or combination thereof. The step of isolation can contain a step of precipitation of the proteins at the isoelectric point followed by a step of centrifugation or a step of filtration using membrane. Examples of preparation of a leguminous protein extract, notably of pea protein extract, are notably disclosed in WO2007/017572, WO2011/124862 or WO2019/053387.

The leguminous protein extract, notably the pea protein extract, implemented in step i), can be in a powder form or in the form of a liquid suspension. In the case of liquid suspension, the suspension is generally an aqueous liquid suspension. Powder forms may be obtained after drying of a leguminous protein suspension with methods such as freeze drying or spray drying.

As an example, commercial products such as the ones commercialized by the applicant under the brand NUTRALYS® can be used in step i) as a pea protein extract, such as NUTRALYSRS85F or NUTRALYS®F85M.

Typically, the pea protein can be obtained by resuspending pea flour in water, separating and recovering the soluble material by centrifugation, adjusting at an acidic pH (e.g. at a pH ranging from 4.0 to 5.5) the soluble material to precipitate the protein contained in the soluble material and optionally heating the soluble material (e.g. at a temperature going from 55 to 75° C.) during, before or after the acidification and subjecting to a further centrifugation in order collect the underflow comprising pea protein.

### Step ii)

In step ii), the pH of the aqueous suspension obtained in step i) is adjusted to a value comprised in the range of from 8.0 to 9.5.

In some embodiments, the pH of the aqueous suspension obtained in step i) is adjusted to a value comprised in the range of from 8.0 to 8.5; from 8.5 to 9.0; from 9.0 to 9.5; or preferably from 8.2 to 8.8 or around 8.5. It has been found that within the preferred ranges of pH values, the leguminous protein extract obtained displays better color and taste compared to when the alkaline treatment is performed at a higher pH, notably higher than 9.5.

As used herein, the term “around” a value means that value±5%, notably 3%, or 1%.

To adjust the pH, any kind of caustic solutions that can be used for food ingredient manufacturing can be used. Examples of caustic solutions include notably sodium hydroxide, potassium hydroxide and/or calcium hydroxide.

In a preferred embodiment, this pH adjustment is performed by adding an aqueous solution of sodium and/or potassium hydroxide, preferably an aqueous solution containing both sodium and potassium hydroxide in a molar ratio ranging from 10:90 to 90:10, most preferably ranging from 40:60 to 60:40.

Surprisingly, it has been discovered by the applicant that the use of a combination of sodium and potassium hydroxide to adjust the pH enabled to further improve the gel properties, notably the firmness, as compared to sodium or potassium hydroxide alone.

Step iii)

In step iii), the suspension of step ii) is heated at a temperature ranging from 80° C. to 160° C. during a time sufficient to increase the storage modulus and/or the gel strength ratio of the leguminous protein extract.

In a preferred embodiment, the heating step iii) is performed during a sufficient time to reach a storage modulus of a least 1800 Pa, advantageously of at least 2000 Pa, more preferably of at least 2500 Pa when determined using TEST A.

In some embodiments, the heating step iii) is performed during a sufficient time to reach a gel strength ratio of at least 1.5, notably of at least 2.0, preferably of at least 2.3.

In some embodiments, the heating step iii) is performed during a sufficient time to reach a firmness of at least 100 g, when determined using TEST B.

In some embodiments, the heating step iii) is performed during a sufficient time to reach a firmness ratio of at least 1.2, notably of at least 1.5, preferably at least 2.0.

The time of the heating step iii) may notably range from 0.1 second(s) to 10 minutes (min), preferably from 0.1 s to 1 min, notably from 0.5 s to 50 s, preferably from 1 s to 40 s, most preferably from 2 s to 30 s or 5 s to 20 s.

At the end of step iii), the suspension is generally cooled, notably down to a temperature ranging from 50 to 95° C., preferably ranging from 60 to 85° C. The cooling may be performed by flash cooling.

### Step iv)

The method of preparation of the acid-gelling protein extract may further comprise a step iv) consisting in adjusting the pH of the heat-treated suspension of step iii) to a value ranging from 5.0 to 8.0, notably from 5.0 to 6.0; from 6.0 to 7.0 or from 7.0 to 8.0.

The acidification step iv) may notably be performed by adding hydrochloric acid to the suspension obtained further to step iii).

Step iv) may notably be performed after cooling of the suspension obtained in step iii).

This step iv) allows to modify the pH of the acid-gelling leguminous protein extract of the invention. Any kind of food grade acids can be used for this optional step, such as hydrochloric acid or citric acid.

### Step v)

The method of preparation of the acid-gelling protein extract according to the invention further comprises a step of recovering the obtained acid-gelling leguminous protein extract.

### Step vi)

The method of preparation of the acid-gelling protein extract according to the invention may further comprise a step of drying the recovered acid-gelling leguminous protein extract.

Step vi) may notably be performed by spray-drying, or freeze-drying.

Step vi) may be performed under conditions enabling to obtain an acid-gelling leguminous protein extract having a moisture content of less than 10%, notably of less than 7%, relative to the total weight of the acid-gelling leguminous protein extract.

### Use of the Leguminous Acid-Gelling Protein Extract

In a third aspect, the invention provides a use of a leguminous acid-gelling protein extract in food products, especially acid-gelling food products, such as yogurts, cheeses, acidic spreads such as margarine, butter alternative, jam, or marmalade, acidic beverages especially acidic jelly beverage, jelly, sour cream, creme fraîche, whipping cream or acidic sauces.

One further aspect of the invention is also a method of improving the acid-gelling properties of a food product, the food product comprising a leguminous acid-gelling protein extract, notably a pea acid-gelling protein extract.

In some embodiments, acid-gelling food products can have a pH of 3 to 6 when diluted at a dry matter of 10%. The leguminous acid-gelling protein extract can be used to form a milk, which is fermented and/or acidified to provide yogurts and cheeses. These milks can present a dry matter going from 5 to 30%. These milks can comprise other components such as sugars, fats and optional ingredients. Yogurts can include stirred yogurts, set yogurts or yogurts to drink. These can be flavoured or not and can include other components such as fruit preparations and/or sweeteners. Cheeses can be analogues of process cheese, swiss cheese, string cheese, ricotta, soft-rippened cheeses such as camembert, Munster or brie, provolone, parmesan, mozzarella, jack, manchego, blue, fontina, feta, edam, double Gloucester, cheddar, asiago and Havarti. Acidic sauces are for example mayonnaise or ketchup. All these food-products can be vegan food products or can comprise some amount of ingredients from animal origin.

In some embodiments, the pea protein composition of the invention can be used in food and beverage products that may include the pea protein composition in an amount of up to 100% by weight relative to the total dry weight of the food or beverage product, for example in an amount of from around 1% by weight to around 80% by weight relative to the total dry weight of the food or beverage product. All intermediate amounts (i.e. 2%, 3%, 4% . . . 77%, 78%, 79% by weight relative to the total weight of the food or beverage product) are contemplated, as are all intermediate ranges based on these amounts. Food or beverage products which may be contemplated in the context of the present invention include baked goods; sweet bakery products (including, but not limited to, rolls, cakes, pies, pastries, and cookies); pre-made sweet bakery mixes for preparing sweet bakery products; pie fillings and other sweet fillings (including, but not limited to, fruit pie fillings and nut pie fillings such as pecan pie filling, as well as fillings for cookies, cakes, pastries, confectionary products and the like, such as fat-based cream fillings); desserts, gelatins and puddings; frozen desserts (including, but not limited to, frozen dairy desserts such as ice cream-including regular ice cream, soft serve ice cream and all other types of ice cream- and frozen non-dairy desserts such as non-dairy ice cream, sorbet and the like); carbonated beverages (including, but not limited to, soft carbonated beverages); non-carbonated beverages (including, but not limited to, soft non-carbonated beverages such as flavored waters, fruit juice and sweet tea or coffee based beverages); beverage concentrates (including, but not limited to, liquid concentrates and syrups as well as non-liquid ‘concentrates’, such as freeze-dried and/or powder preparations); snack bars (including, but not limited to, cereal, nut, seed and/or fruit bars); bread products (including, but not limited to, leavened and unleavened breads, yeasted and unyeasted breads such as soda breads, breads comprising any type of wheat flour, breads comprising any type of non-wheat flour (such as potato, rice and rye flours), gluten-free breads); pre-made bread mixes for preparing bread products; sauces, syrups and dressings; sweet spreads (including chocolate, nut spreads and other spreadable preserves, conserves and the like); confectionary products (including, but not limited to, jelly candies, soft candies, hard candies, chocolates and gums); sweetened and un sweetened breakfast cereals (including, but not limited to extruded breakfast cereals, flaked breakfast cereals and puffed breakfast cereals); and cereal coating compositions for use in preparing sweetened breakfast cereals. Other types of food and beverage product not mentioned here but which conventionally include one or more nutritive sweetener may also be contemplated in the context of the present invention. In particular, animal foods (such as pet foods) are explicitly contemplated. It can also be used, eventually after texturization by extrusion, in meat-like products such as emulsified sausages or plant-based burgers. It can also be used in egg replacement formulations.

The food or beverage product can be used in specialized nutrition, for specific populations, for example for baby or infants, elderly people, athletes, or in clinical nutrition (for example tube feeding or enteral nutrition).

In these food products and especially acid-gelling food products, the leguminous acid-gelling protein extract can be the sole source of protein. Alternatively, the leguminous acid-gelling protein extract is used in combination with another source of protein and can be used in combination with other plant and/or animal proteins. The term “plant protein” denotes all the proteins derived from cereals, oleaginous plants, leguminous plants and tuberous plants, and also all the proteins derived from algae and microalgae or fungi, used alone or as a mixture, chosen from the same family or from different families. In the present application, the term “cereals” is intended to mean cultivated plants of the grass family producing edible grains, for instance wheat, rye, barley, maize, sorghum or rice. The cereals are often milled in the form of flour, but are also provided in the form of grains and sometimes in whole-plant form (fodders). NUTRALYS® W, which is wheat protein extract commercialized by the Applicant, can be cited as example of wheat protein source. NUTRALYS® RICE 1800XF and NUTRALYS® RICE 1850XF, which are rice protein extracts commercialized by the Applicant, can be cited as example of rice protein sources. In the present application, the term “tubers” is intended to mean all the storage organs, which are generally underground, which ensure the survival of the plants during the winter season and often their multiplication via the vegetative process. These organs are bulbous owing to the accumulation of storage substances. The organs transformed into tubers can be the root e.g. carrot, parsnip, cassava, konjac), the rhizome (e.g. potato, Jerusalem artichoke, Japanese artichoke, sweet potato), the base of the stalk (more specifically the hypocotyl, e.g. kohlrabi, celeriac), the root and hypocotyl combination (e.g. beetroot, radish). The animal protein can be for example egg or milk proteins, such as whey proteins, casein proteins or caseinate. The leguminous acid-gelling protein extract can thus be used in combination with one or more of these proteins or amino acids in order to improve the nutritional properties of the final product, for example to improve the PDCAAS of the protein or to bring other or modify functionalities.

In one embodiment, a rice protein extract is used in the food product, especially in the acid gelling food product, in combination with pea protein extract. Preferably, these are used in quantities such that the rice protein extract/pea protein extract dry weight ratio goes from 10:90 to 50:50, for example from 20:80 to 40:60.

### Food Products Comprising an Acid-Gelling Protein Extract

In a fourth aspect, the invention provides food products, especially acid-gelling food products comprising a leguminous acid-gelling protein extract, notably a pea acid-gelling protein extract.

The acid-gelling food product may be notably yogurts, cheeses, acidic spreads such as margarine, butter alternative, jam, or marmalade, acidic beverages especially acidic jelly beverage, jelly, sour cream, creme fraîche, whipping cream or acidic sauces.

### Leguminous Protein Extract for Powder Preparations for Beverages

In the alternative a leguminous protein extract is used in powder mix applications, this leguminous protein does not require any acid-gelling properties.

In the field of powder preparations for beverages, also called “powder mix beverages”, “powder mix” or “ready to mix beverages”, the growing demand for protein sources, including plant-based protein sources, has led to the exploration of innovative protein ingredients that deliver enhanced sensory properties, such as creaminess and mouthfeel. However, concerning leguminous-plant proteins available in the market, one drawback is that their behavior is different from animal milk proteins in terms of texture in the mouth: they generally give lower creaminess, lower mouthfeel, and higher chalkiness. One solution for improving some of these attributes has been developed but does not give full satisfaction. For example, WO2020/007940 A1 describes a rehydratable food composition comprising pea proteins and a potassium metaphosphate with lower chalkiness when rehydrated; however, this solution is still limited as, for example, the document does not disclose improved creaminess. There is still a need to provide new leguminous protein extracts able to improve the texture in the mouth of powder mix formulations.

Moreover, certain protein extracts do present a low suspensibility in water. When used in a powder mix formulation, this drawback is especially challenging because, to be utilized by the consumer, the powder mix is generally incorporated in a protein-shaker with water and the powder is suspended by shaking. Foaming occurs during that step. The shaker is then allowed to stand, so that the foam quantity reduces. The protein powder can also hydrate during that period, this hydration contributing to the texture. To obtain good sensory of the powder beverage when consumed, it is thus very important that the protein is maintained in suspension during the time it is allowed to stand.

Furthermore, the recipe of a powder mix formula may comprise very numerous ingredients to provide the desired attributes. For example, hydrocolloids such as xanthan gum may be used to provide increased mouthfeel to the powder mix formula. So, it may be helpful to provide powder mix formulas with good texture that would not comprise (or would have more limited quantities of) xanthan gum or more generally hydrocolloids. It is also possible that the powder formula comprises emulsifiers to improve the global suspensibility of the protein powder. To the same extent, it can be helpful to provide powder mix formulas with improved suspensibility that would not comprise (or would have more limited quantities of) emulsifiers. So, there is a need for new powder preparation for beverages using leguminous proteins that can solve these issues.

It also appears from above that there is a need to provide new leguminous proteins that allows the manufacture of powder preparation of beverage with improved sensation of creaminess, smoothness and/or lower chalkiness. It may also be helpful to provide ingredients that can decrease the number of ingredients in the formulation or lower the quantities of hydrocolloids and/or emulsifiers used in the powder mix formula. It is also needed that leguminous protein extracts provide to the powder mix increased suspensibility. One other objective is also to provide leguminous protein extracts that can render the powder mix beverages less foamy after shaking.

It is an alternative embodiment that relates to a leguminous protein extract that has a protein content, expressed on dry weight basis of the extract, of 75% or higher, a dry matter ranging from 90 to 100%, wherein the protein extract has a Turbiscan Stability Index TSI at the Middle Region TSIMR at 15 minutes below 5.0 and a rheometer viscosity going from 0.40 to 0.75 Pa·s, the viscosity being determined at 20° C., with a shear rate of 40 s-1, on an aqueous suspension having 15% weight of dry matter.

This leguminous protein extract can be made by the process of the invention, with a mandatory drying step included at the end of the process, so that the protein extract reaches the desired dry matter. For example, the embodiment of Example 7 provides detailed information on these properties of this leguminous protein extract.

In some embodiments, the leguminous protein extract included in the powder preparation for beverages has at least one of the following additional features:
it has a mean particle size d50 size going from 10 to 400 microns or from 20 to 200 microns or 30 to 100 microns;
it has a TSIMR at 15 minutes going from 0.5 to 3.0 or from 0.5 to 2.0;
it has a rheometer viscosity going from from 0.42 to 0.75 Pa·s or from 0.45 to 0.70 Pa·s or from 0.48 to 0.65 Pa·s;
it has CIE a*value that goes from −3 to +3;
it has CIE b*value that goes from +10 to +20.

This leguminous extract may combine one of several of these attributes with the ones of the acid-gelling leguminous protein extract described previously.

The leguminous protein extract can have a dry matter ranging from 90 to 100%. The dry matter can be calculated by any relevant method, including AOAC Official Method of Analysis 925.10, Solids (Total) and Loss on Drying (Moisture) in Flour.

The leguminous protein extract can have a Turbiscan Stability Index TSI at the Middle Region TSIMR at 15 minutes below 5.0.

Turbiscan is a well-known apparatus that allows one to determine the suspensibility of a suspension during time. The Turbiscan apparatus records and provides 3 values: one Turbiscan Stability Index for the Top Region, one Turbiscan Stability Index for the Middle Region, one Turbiscan Stability Index for the Bottom Region. Averages of these 3 values represent the global Turbiscan Stability Index TSI. In the case of evaluation of the protein, because foam is present at the top of every sample, Turbiscan Stability Index at the top Region of the measurement cell are more representative of the foam stability kinetics and less representative of the suspensibility and sedimentation of the protein. Average of Turbiscan

Stability Index of Middle Region is more accurate to represent the suspensibility of the protein powder inside a powder shake. The different TSI at 15 minutes are reported. Turbiscan Stability Index analysis are conducted on an aqueous suspension at 6.5% of weight of protein N6.25. A detailed protocol to determine TSI is reported in the example section.

Preferably, the leguminous protein has a TSIMR at 15 minutes going from 0.5 to 3.0 or from 0.5 to 2.0.

Preferably, the leguminous protein has a TSIBR at 15 minutes going from 0.5 to 3.0 or from 0.5 to 2.0. The TSIBR is more representative of the sedimentation of the protein at the bottom of a shaker. The TSI at 15 minutes of the leguminous protein can be up to 4.0, for example from 0.5 to 3.5.

The rheometer viscosity can be determined at 20° C. using a rheometer at a frequency of 40 s-1 by using a solution of the leguminous protein extract having 15% of dry matter. Rheometers helpful to determine the rheometer viscosity include a rheometer equipped with a concentric cylinder measuring system used in rotational mode. It can be Anton Paar Model MCR92 equipped with CC39 measuring system. In the Examples section can be found details on the sample preparation and on the equipment that can be used, with details on the program.

Preferably, the leguminous protein extract has a rheometer viscosity going from 0.42 to 0.75 Pa·s or from 0.45 to 0.70 Pa·s or from 0.48 to 0.65 Pa·s.

The leguminous protein extract is generally a powder. It may be a spray-dried powder or a freeze-dried powder, preferably spray dried powder. The powder can have a mean particle size d50 size going from 10 to 400 microns or from 20 to 200 microns or 30 to 100 microns. Several methods can be used for measuring particle size and particle size distribution. Some of them are based on light, or on ultrasound, or electric field, or gravity, or centrifugation. The use of sieves is a common measurement technique. In the present application, the use of laser diffraction method is preferred. As for “mean particle size” (d50) determined by laser diffraction, this mean particle size is a volume-weighted mean particle size. The skilled person will be able to select a laser diffraction method allowing him to obtain an accurate mean particle size determination. For example, d50 can be measured by a laser granulometry apparatus (Mastersizer 3000, from Malvern), which measures intensity of scattered light across a range of scattering angles using forward scattering measurement, on a dry powder without dispersion buffer, and using the software of the apparatus with the Mie scattering model to fit the distribution to the measured scattering pattern.

The leguminous protein extract may have a CIE a*value that goes from −3 to +3 and/or b*value that goes from +10 to +20. The CIELAB color space, also referred to as L*a*b*, is a color space defined by the International Commission on Illumination (abbreviated CIE) in 1976. It expresses color as three values: L* for perceptual lightness and a* and b* for the four unique colors of human vision: red, green, blue and yellow. The a* and b* values are determined on an aqueous suspension at 6.5% of weight of protein N6.25. The a and b* values may be determined using Konica Minolta CM-5 Colorimeter with the following test Conditions: D65/10°. A detailed protocol to determine a* and b* is reported in the example section.

More details on the advantages of this leguminous protein extract are described into more details in Examples 7 to 9.

A method of using the leguminous protein extract for manufacturing a powder preparation for beverages is one of the disclosed embodiments. A powder preparation for beverages comprising the leguminous protein extract is also one of the disclosed embodiments.

Alternatively, the leguminous protein extract useful for a powder preparation for beverages can be:
an acid-gelling leguminous protein, for example a leguminous protein extract having a protein content, expressed on dry weight basis of the extract, of 75% or higher and a storage modulus of at least 1800 Pa; and/or
a leguminous protein extract obtainable by the process described in the present document.

### Examples

### Methods

### Determination of pH of Protein Extracts

20 g of dry powder of pea protein extract was dispersed at room temperature (around 22° C.) in 180 g of distilled water using an overhead mixer with a 3-blade agitator to produce a slurry. The slurry was stirred for 30 min to hydrate the powder and pH of the slurry was determined using pH meter. These are reported in Tables below under the title: “pH pea protein extract”.

### Methods to Evaluate Acid-Gelling Properties

### Acid Gel Properties: Sample Preparation

For each pea protein extract, 20 g of dry powder of pea protein extract was dispersed at room temperature (around 22° C.) in 380 g of distilled water using an overhead mixer with a 3-blade agitator to produce a slurry. The slurry was stirred for 30 min to hydrate the powder. The slurry was then transferred to a Thermomix TM6 [Vorwerk] and heated to 95° C. while stirring. After a 5 min hold time at 95° C. the heat was turned off on the Thermomix and the material was allowed to cool to approximately 70° C. while still under agitation. Finally, the slurry was poured into a beaker and cooled in an ice bath until the temperature reached 20-22° C. The beaker was removed from the ice bath. Then 0.75% glucono-delta-lactone (GDL) expressed in dry weight was added to the sample and stirred for 2 minutes.

### Determination of Acid Gel Strength and Acid Gel Strength Ratio

The determination of the storage modulus according to the TEST A were done following the below procedure: the pH of the GDL acidified samples were monitored during acidification using a SPER pH SD card datalogger. The rheological properties (storage and loss moduli) of the GDL acidified samples were monitored maintaining the samples at 22° C. during acidification using a rheometer (Anton Parr Model MCR92) equipped with a concentric cylinder measuring system (CC39: cup diameter 42 mm; bob diameter 38.7 mm) that is filled with the recommended amount (approximately 65 g) applying a strain of 0.2% at a frequency of 1 Hz. The strain applied was within the linear viscoelastic region of the sample. Once the pH of the acidified sample has reached 4.5, the storage modulus (G′) is measured and corresponds to the storage modulus according to TEST A.

The acid gel strength ratio represents the improvement due to the alkaline heat treatment. It is determined by measuring the storage modulus (G′) using the Test A of one alkaline pH heat-treated pea protein extract and the storage modulus (G′) using the Test A of one pH 7.0 heat-treated pea protein extract. All other processing parameters to produce the two pea protein extracts are identical. The gel strength ratio was calculated using the following equation:

$$\underline{Acid gel firmness ratio = Firmness ( g ) of the alkaline heat treated pea} \underline{protein / Firmness ( g ) of the neutral pH heat treated pea protein .}$$

### Determination of Acid Gel Firmness and Firmness Ratio

To determine the firmness of the gel, 65 g of the GDL acidified samples prepared as described above was placed into 4 oz glass jars immediately after addition of GDL and stirring. The samples were incubated at ˜22° C. for 22-24 hours. Firmness was measured according to the following test B, using a Texture Technologies Corp. TA.HD.plus equipped with a 5 kg load cell. A 1-inch diameter cylindric probe was penetrated into the sample under the following parameters: pre-test speed=1 mm/sec, test speed=0.5 mm/sec, post-test speed=10 mm/sec, distance=15 mm, trigger force=5 g. The firmness is defined as the highest force measured during the 15 mm penetration of the sample. In the same manner than for the acid gel strength ratio, the measure of firmness of the acid gels for the alkaline pH heat-treated pea protein and for the pH 7.0 heat-treated pea protein allows to determine the gel firmness ratio, which is calculated using the following equation:

$$\underline{Gel strength ratio = ( {G}_{acid}^{′} ) of the alkaline heat} \underline{treated pea protein / ( {G}_{acid}^{′} ) of the neutral pH heat pea protein .}$$

### Methods to Evaluate the Use in Powder Mix Applications

### Preparation of the Sample to Test Sensory Evaluation, Suspensibility and Color Properties of the Leguminous Protein Extract

Place 354 g of water (10-15° C.) and protein powder together in a protein shaker bottle (Blender Bottle C01626, capacity 28 Oz) in order to reach 6.5% by weight of protein N6.25 (around 32 g of powder) in the protein solution. Blender bottle C01626 is equipped with a ball system that prevents the powder from clumping to make a more homogeneous suspension. Similar shaker may be used to obtain same results. To ensure proper mixing of the protein solution within the shaker bottle, vigorously shake the bottle with 30 up-and-down motions (1 motion is one up-and-down).

### Determination of the Rheometer Viscosity of the Protein Extract

The rheometer viscosity was determined by preparing a protein solution by combining 30 g of dry protein extract and dispersing at room temperature (around 20° C.) in 170 g of distilled water, using an overhead mixer with a 3-blade agitator, so that the dry matter of the protein solution is 15%. A quantity of 0.02% sodium azide, expressed in dry weight, was added in the slurry to prevent bacterial growth. The slurries were stirred overnight to ensure complete hydration of the powders. After 12 hours, the viscosity was measured using a rheometer (Anton Paar Model MCR92) in rotational mode equipped with a concentric cylinder measuring system (CC39: cup diameter 42 mm; bob diameter 38.7 mm) that is filled with the recommended amount (approximately 65 g) of the hydrated slurry. The viscosity is measured at 20° C. over a shear rate of 5 to 600 s-1. The viscosity at a shear rate of 40 s-1 is reported for comparison.

### Determination of the RVA Viscosity of the Powder Preparations for Beverages

Equipment: RVA 4500 Viscometer with Julabo F12-ED Refrigerated/Heating Circulator, Plastic Paddle, and Aluminum Canisters.
Test Conditions: Incubation Temperature of 20° C., Mixing Rate of 160 rpm, Holding Time of 5 Minutes, Sample Weight of 28 g.
Measurement Scale/Units: Viscosity (cP).
Turn on both the RVA Viscometer and the F12-ED Water Circulator.
Calibrate the RVA Viscometer by attaching a plastic paddle to the coupling and zero the viscosity.
Wait 15 minutes for the protein shake solution to equilibrate before beginning this test.
Set a program that uses a temperature setpoint of 20° C., a mixing rate of 160 rpm, a holding time of 5 minutes, and a sample weight of 28 g.
Weigh out 28 g of the sample into the aluminum canister.
Insert the plastic paddle into the filled canister and slide these two parts together into the RVA Motor Coupling (an audible click should be heard with plastic notches locking into the coupling).
Once the device displays, “Test Ready,” depress the RVA Tower into the RVA Viscometer to begin the test.
Record the terminal viscosity reading after the holding time of 5 minutes of mixing (cP) once the test completes.
Perform this testing in triplicate for each sample and calculate the average.

### Suspensibility: Turbiscan Stability Index Determination

Equipment: Turbiscan LAB (Turbidimeter), 150-ml beaker, Turbiscan Glass Measurement Cells (Including Lids and Teflon Disks) having a volume of 20 mL, and Measurement Cell Sample Holder.
Test Conditions: Incubation Temperature of 20° C.
Measurement Scale/Units: Measurement of Kinetic Stability (TSI).
Turn on the Turbidimeter and ensure that the temperature of the incubator is set to 20° C.
Prepare the protein shake solution as per the formulation instructions and pour it into a 150 ml beaker. Immediately fill the Turbiscan measurement cell with the protein shake solution up to the optimal sample fill volume (indicated by the plastic measurement cell sample holder-meniscus to the line).
Insert a Teflon disk (with the grey vinyl side facing downwards) into a black cap and securely tighten this cap onto the filled measurement cell.
Place the sample measurement cell into the Turbiscan LAB turbidimeter and close the lid.
Set the instrument to perform stability testing over 15 minutes, with scans every 25 seconds to detect transmission and back scattering, and start the measurement.
Record the final Turbsican Stability Index (TSI) values. The Turbiscan apparatus records and provides 3 values: one Turbiscan Stability Index for the Top Region, one Turbiscan Stability Index for the Middle Region, one Turbiscan Stability Index for the Bottom Region. Averages of these 3 values represent the global “TSI”.
Perform this testing in duplicate for each sample and calculate the average TSI values.

### Color Determination

Equipment: Konica Minolta CM-5 Colorimeter
Test Conditions: D65/10°-Measurement Scale/Units: CIE L*A*B*
Turn on and calibrate the white measurement of the colorimeter.
Place a flat portion of the sample over the 30 mm equipment opening to completely cover the color measurement area.
Place the sample on the colorimeter and press “Measure”
Once a color measurement is taken, repeat steps 3-4 for a total of 3 measurements, changing the position of the samples to record more representative color measurements.
Record an average of 3 color measurements and calculate the average

### Foamability.

Equipment: HealthMaster® Elite Model LWHME Blender and 1000 mL Graduated Cylinders.
Measurement Scale/Units: Foamability is the volume of Foam Produced (mL)
Place 354 g of purified/filtered refrigerated water and 40 g of powder mix together in the HealthMaster® Elite Model LWHME Blender.
Blend on the Speed 1 Setting (21,750 rpm) for 10 seconds.
Pour the protein shake into a 1000 mL graduated cylinder.
Record initial observations of the foam, volume produced (foamability), and appearance (i.e., coarse and/or fine foam present).
Repeat step 4 after 15 minutes of stand time for a final volume reading.
Subtract the final volume of the foam from the initial volume to obtain a foam stability reading as the difference in mL.
Perform this testing in duplicate for each sample and calculate the average.

### Example 1: Alkaline pH Adjustment Prior to Heat Treatment Resulting in Increased Gel Strength

Pea flour obtained from dried yellow peas was blended with 40° C. water at a weight ratio of around 1:4.5 and stirred for approximately 10 minutes before separating using a Flottweg decanter to remove the insoluble starch and fiber components. The protein containing overflow was acidified to pH 5 using hydrochloric acid and heated using indirect steam heating to 55° C. and held for 20 minutes to facilitate coagulation of the isoelectrically precipitated globulin proteins. The protein was separated from the other soluble components using the Flottweg decanter to form a concentrated protein acid curd. The protein acid curd was diluted to 12% solids using water, equilibrated to ˜40° C., and pH adjusted to 7.0 using sodium hydroxide. The sample was then passed through a shear device to ensure homogeneity of the sample before heating with direct steam injection to 140° C. for 10.5 seconds and flash cooling to 70° C. The sample was homogenized to prevent any protein aggregates from blocking the spray dryer nozzle before spray drying at an inlet temperature of 210° C. and an outlet temperature of 90° C. to a moisture content of <7%.

This process was repeated 2 more times. The second sample was adjusted to pH 8.0 using sodium hydroxide before heat treatment and the third sample was pH adjusted to 9.0 using sodium hydroxide before heat treatment. All other process parameters were the same for all 3 samples.

Table 1 lists the acid gel strength and firmness for pea protein
isolates obtained after a heat treatment at pH 7.0, 8.0, or
9.0. Further, the pH of the dried pea protein extract obtained
after the corresponding heat treatment has been measured.

| | Heat | pH pea | Gel | Gel | | |
|---|---|---|---|---|---|---|
| | Treatment | protein | Strength | Strength | Firmness | Firmness |
| Sample | pH | extract | (Pa) | Ratio | (g) | Ratio |
| 1 | 7.0 | 7.0 | 1301 | — | 82.0 | — |
| 2 | 8.0 | 8.0 | 2032 | 1.6 | 106.2 | 1.3 |
| 3 | 9.0 | 8.9 | 3210 | 2.5 | 145.0 | 1.8 |

Increasing the pH at which the ingredient was heat treated demonstrated increased gel strength and firmness of the acid gel. As the pH of heat treatment increased, the gels developed cracks during the acidification process (especially for sample 3 heat treated at pH 9.0). These cracks weakened the gels and resulted in a lower increase for gel firmness ratio compared to gel strength ratio.

### Example 2: Effect on the Use of Different Caustics in the Improvement of Gel Properties

Pea flour derived from dried yellow peas was blended with 40° C. water at a ratio of 1:4.5 and stirred for approximately 10 minutes before separating using a Flottweg decanter to remove the insoluble starch and fiber components. The protein containing overflow was acidified to pH 5 using hydrochloric acid and heated using indirect steam heating to 55° C. and held for 20 minutes to facilitate coagulation of the isoelectrically precipitated globulin proteins. The protein was separated from the other soluble components using the Flottweg decanter to form a concentrated protein acid curd. The curd was diluted to ˜15% solids using water, divided into 8 portions and kept at room temperature until further processing the same day.

Each portion was pH adjusted (see table below for details on pH and description of caustic(s)), passed through a shear device to ensure homogeneity of the sample and heated with direct steam injection to 140° C. for 10.5 seconds and flash cooled to 70° C. Afterwards the samples were frozen overnight before freeze drying to a moisture content of <7%.

Table 2 describes the caustic used for pH adjustment, the
ingredient heat treatment pH, and acid gel firmness and ratio.
Further, the pH of the pea protein extract obtained after
the corresponding heat treatment has been measured.

| | | Ingredient | | | |
|---|---|---|---|---|---|
| | | heat | pH pea | | |
| | | treatment | protein | Firmness | Firmness |
| Sample | Caustic | pH | extract | (g) | ratio |
| A | 3M NaOH | 7.0 | 7.1 | 110.6 | — |
| B | 3M NaOH | 9.0 | 8.7 | 171.5 | 1.6 |
| C | 1.5M NaOH + | 7.0 | 6.9 | 119.1 | — |
| | 1.5M KOH | | | | |
| D | 1.5M NaOH + | 9.0 | 8.7 | 186.6 | 1.6 |
| | 1.5M KOH | | | | |
| E | 3M KOH | 7.0 | 7.1 | 100.3 | — |
| F | 3M KOH | 9.0 | 8.7 | 159.9 | 1.6 |
| G | 2M NaOH + 1M | 7.0 | 7.2 | 71.0 | — |
| | Ca(OH)₂ | | | | |
| H | 2M | 9.0 | 8.5 | 118.2 | 1.6 |
| | NaOH + 1M | | | | |
| | Ca(OH)₂ | | | | |

It is observed that, despite the decrease in firmness with the use of divalent cation containing caustic (for example, 110 g NaOH→71 g Ca(OH)₂), alkaline heat treatment produces a pea protein isolate with increased firmness compared to its corresponding neutral pH heat treated control pea protein isolate. What is even more surprising is that use of blends of NaOH and KOH provide improved gel properties, compared to the use of NaOH or KOH alone.

Further, to determine whether the protein became denatured after the heat treatment regardless of the pH at which the heat treatment was conducted, differential scanning calorimetry measurements were performed before and after the heat treatment, on the NaOH caustic samples heat treated at pH 7 and pH 9 (samples A and B respectively). Pre heat treatment samples were collected and freeze dried in the same manner as the post heat treatment samples. 10% protein solutions were prepared using deionized water. 34-36 mg of each slurry was placed in a hermetically sealed high volume stainless steel pan and heated from 5° C. to 150° C. at a heating rate of 10° C./min in a TA Instruments Discovery DSC250. The denaturation onset and peak temperatures were recorded, and the denaturation enthalpy was calculated using Trios software.

Table 3 describes the differential scanning calorimetry parameters
for pea protein isolates exposed to heat treatment at different pH.

| | | Onset | Peak | |
|---|---|---|---|---|
| Protein | Heat | Temperature | Temperature | Enthalpy (J/g |
| Sample pH | Treatment | (° C.) | (° C.) | sample) |
| 7 | None | 74.8 | 86.6 | 0.38 |
| 7 | 140° C./10.5 | 97.4 | 100.5 | 0.022 |
| | sec | | | |
| 9 | None | 66.5 | 83.4 | 0.15 |
| 9 | 140° C./10.5 | No denaturation peak detected (0 J/g) | | |
| | sec | | | |

There is a significant decrease in the enthalpy of denaturation for the pH 7 post heat treatment sample and no denaturation peak detected for the pH 9 post heat treatment sample. These results indicate that the protein is denatured using a heat treatment of 140° C. for 10.5 seconds regardless of the pH of the sample.

### Example 3: Impact of Neutralization to pH 7 after Heat Treatment/Before Spray Drying

Pea flour derived from dried yellow peas was blended with 40° C. water at a ratio of 1:4.5 and stirred for approximately 10 minutes before separating using a Flottweg decanter to remove the insoluble starch and fiber components. The protein containing overflow was acidified to pH 5 using hydrochloric acid and heated using indirect steam heating to 55° C. and held for 20 minutes to facilitate coagulation of the isoelectrically precipitated globulin proteins. The protein was separated from the other soluble components using the Flottweg decanter to form a concentrated protein acid curd. The curd was diluted to ˜17% solids using water, divided into 2 portions, and kept at room temperature until further processing the same day.

The first portion was equilibrated to ˜60° C. and pH adjusted to 8.5 using a blend of 1.5N sodium hydroxide+1.5N potassium hydroxide before adding additional water to reach a final solids concentration of 15%. The sample was then passed through a shear device to ensure homogeneity of the sample before heating with direct steam injection to 140° C. for 10.5 seconds and flash cooling to 70° C. The sample was homogenized to prevent any protein aggregates from blocking the spray dryer nozzle before spray drying at an inlet temperature of 210° C. and an outlet temperature of 90° C. to a moisture content of <7%. The second portion was equilibrated to ˜60° C. and pH adjusted to 8.5 using a blend of 1.5N sodium hydroxide+1.5N potassium hydroxide before adding additional water to reach a final solids concentration of 15%. The sample was then passed through a shear device to ensure homogeneity of the sample before heating with direct steam injection to 140° C. for 10.5 seconds and flash cooling to 70° C. While maintaining the temperature at ˜65° C., 3N hydrochloric acid was added to reduce the pH to 7.0. The neutralized sample was homogenized to prevent any protein aggregates from blocking the spray dryer nozzle before spray drying at an inlet temperature of 210° C. and an outlet temperature of 90° C. to a moisture content of <7%.

Table 4 compares the gel strength and firmness of 5% acid gels produced
from the non-neutralized and neutralized samples. Further, the
pH of the pea protein extract obtained after the corresponding
heat treatment and optional neutralization has been measured.

| | pH pea protein | Storage Modulus, | |
|---|---|---|---|
| Sample | extract | G′ (Pa) | Firmness (g) |
| Non-neutralized | 9.0 | 2538 | 137 +/− 9 |
| Neutralized | 7.2 | 2168 | 112 +/− 6 |

### Example 4: Use of the Pea Protein Extracts at Different pH: Influence of the pH when Used

Pea flour derived from dried yellow peas was blended with 50° C. water at a ratio of 1:4.5 and stirred for approximately 10 minutes before separating using a tricanter horizontal centrifuge to remove the insoluble starch and fiber components. The protein containing overflow was acidified to pH 5 using hydrochloric acid and heated using indirect steam heating to 60° C. and held for 10 minutes to facilitate coagulation of the isoelectrically precipitated globulin proteins. The protein was separated from the other soluble components using an Alfa Laval horizontal decanter to form a concentrated protein acid curd. The protein acid curd was diluted to 18% solids using water, equilibrated to ˜60° C., and pH adjusted to 7.0 (control) or 8.5 (invention) using a blend of 5% (w/v) sodium hydroxide+5% (w/v) potassium hydroxide. The samples were then heated with direct steam injection to 135° C. for 15 seconds and flash cooled to 70° C. The samples were pumped using a high shear pump to a spray dryer at an inlet temperature of 210° C. and an outlet temperature of 90° C. and dried into powders with a moisture content of <7%.

Table 5 lists the acid gel properties of the control and invention pea protein
extract samples and the contents of sodium and potassium in the samples.

| | | pH | | | | | | |
|---|---|---|---|---|---|---|---|---|
| | heat | pea | Gel | Gel | | | | |
| | treatment | protein | Strength | Strength | Firmness | Firmness | Sodium | Potassium |
| Sample | pH | extract | (Pa) | Ratio | (g) | Ratio | (ppm) | (ppm) |
| Control | 7.0 | 7.2 | 1011 | — | 68 | — | 5610 | 10600 |
| Invention | 8.5 | 8.6 | 2822 | 2.8 | 183 | 2.7 | 7150 | 13500 |

The Table 5 shows a strong improvement in the acid gelling properties when using alkaline blend of potassium hydroxide and sodium hydroxide. It was quantified that the molar ratio Na: K into the obtained leguminous protein sample is around 50:50.

### Example 5: Characterization of Commercial Legume Protein Isolates

The gel strength were measured for 2 different commercial pea protein isolates.

TABLE 6
lists the acid gel properties.

| | pH pea | Gel |
|---|---|---|
| | protein | Strength |
| Producer | extract | (Pa) |
| Roquette | 7.7 | 1634 |
| NUTRALYS ® | | |
| S85F | | |
| Emsland | 7.4 | 1460 |
| EMPRO-E86 | | |

### Example 6: Yogurts Made with Pea Protein Extracts

The Table 7 lists the different ingredients and quantities used for manufacturing the yogurt base. 2 kg of yogurt were produced per batch using the pea proteins of Example 4.

| | |
|---|---|
| Water | 89.9% |
| Pea protein | 4.1% |
| Granulated sugar | 4.2% |
| Coconut oil | 1.8% |

The set yogurts A and B were manufactured using Control and Invention pea proteins of the Example 4 with the following protocol:
Heat the oil to 70° C. in a lab convection oven
In a Thermomix, Hydrate the pea protein in the water at 55° C. for 30 minutes (speed setting 3)
Add granulated sugar while mixing
After hydration, add the oil to the protein and sugar over 1 minute and then increase mixing speed (speed setting 6) maintaining at 60° C. and mix during 5 minutes
Homogenize in an HP homogenizer at 150 bar (1^{st} stage) and 45 bar (2^{nd} stage) at 60° C.
Pasteurize at 95° C. for 7 minutes while mixing in the thermomix on setting 3
Cool to 42° C. and add 0.0002% of the lactic acid bacteria culture (Vega Harmony), based on weight of yogurt base
Put 150-200 g of cultured yogurt base in a yogurt pot and cover with foil
Incubate at 42° C. until reaching a pH of 4.60
Pack and store at refrigeration temperature (4° C.)

A set yogurt C using the Invention pea protein of the Example 4 was manufactured with the same protocol than set yogurt B except that, before homogenization, lemon juice concentrate was added to the yogurt base until a pH of around 7 was reached.

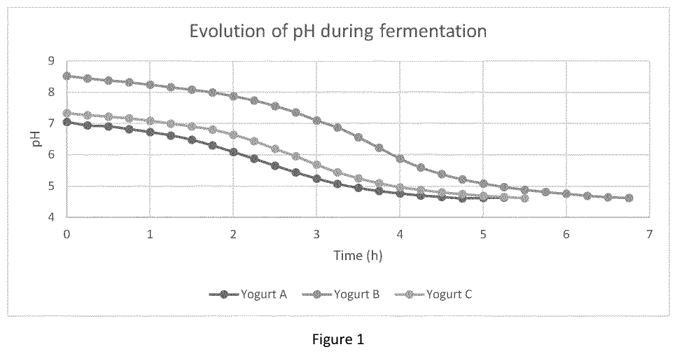

For these tests, the evolution of the pH of the cultured yogurt base vs fermentation time was represented in FIG. 1.

Stirred style yogurts D, E and F were produced using respectively the set yogurts A, B and C: before storing at refrigeration, the yogurts were smoothed with slight homogenization and were refrigerated in the same way than for set yogurts.

For all yogurts, the evolution of the pH was determined during time.

After 7 days, firmness of the yogurts at 4° C. were determined using texture analyzer. Average dynamic viscosity were also measured using a rheometer at 20° C. and 60⁻¹ (Pa·s) and results are reported in Table 8. Because the viscosity test is not a relevant method to study the texture of a set yogurt, only stirred style yogurts were evaluated with this test.

TABLE 8

| | | |
|---|---|---|
| Yogurt | Firmness (g) | Viscosity (cP) |

Set yogurts

| | | |
|---|---|---|
| Yogurt A (reference) | 82.5 | ND |
| Yogurt B | 118.6 | ND |
| Yogurt C | 128.7 | ND |

Stirred style yogurt

| | | |
|---|---|---|
| Yogurt D (reference) | 21.5 | 0.23 |
| Yogurt E | 26.2 | 0.31 |
| Yogurt F | 26.2 | 0.30 |

*ND: not determined

These results demonstrate that the new acid gelling pea protein of the invention allows an improvement of the texture. Further, the texture of the different yogurts were evaluated during an informal tasting session: the yogurts of the invention have also been rated as being more creamy/rich in texture and, overall, the yogurts of the invention were preferred. The fermentation time was decreased (around 2 hours) when neutralizing with the lemon juice concentrate before fermentation.

### Example 7: Manufacturing Leguminous Protein Extracts at Pilot Scale

About 900 kg of pea seeds were used. The outer fibres of the peas were first separated from the seeds by crushing (mechanical separation of the outer shell and the pea seed) and depeeling (sorting the outer husks and the dehulled pea seeds using compressed air). The crushed seeds are then ground in a high-speed attrition mill to obtain pea flour. The flour is then cooled by compressed air. This flour is then rehydrated with water by a high-shear stator rotor system to allow for rapid and efficient hydration of the flour, without any pH adjustment. The crushed pea slurry was cooled to about 8° C. by passing through a plate exchanger and then transferred to a stirred storage tank. A protein fraction was obtained by separating the slurry using hydrocyclones, the liquid fraction being further purified using a decanter, the protein fraction being recovered in the overflow (about 6% dry matter). The protein fraction was adjusted to pH 5 in a stirred tank by adding hydrochloric acid until the desired pH was reached. The protein fraction is then heat-treated by steam injection at 77° C. into a GEA skid for about 5 seconds, after an initial immediate preheating step by passing through a plate heat exchanger. The protein fraction was then immediately flash cooled to 67° C. The heat-treated protein fraction was passed through a Flottweg Z3 decanter centrifuge. The recovered precipitated protein in the underflow was diluted in hot water (60° C.) so that it could be easily pumped. This diluted underflow was adjusted to a dry matter of about 16% and then rectified to pH 8.5 using an aqueous alkaline mixture made of NaOH and KOH (weight ratio 50%/50%), with a total weight concentration of alkali (NaOH and KOH) of 4% of the alkaline mixture. The pH rectified pea protein was heat-treated at 130° C. for 4.3 seconds and then cooled by flash cooling to about 70° C. This heat treated pea protein was pumped using high-pressure pump to the atomizer and then atomized in a TGE nozzle atomizer (inlet temperature 200° C., outlet temperature 60° C.).

A control sample was also produced which differed in that, before heat treatment at 130° C., the pH was rectified at 7.0 instead of 8.5 and that the alkaline mixture used was made of NaOH with a total weight concentration of NaOH of 4% of the alkaline mixture.

The recovered pea protein powder was analyzed and results are reported in Table 9 below

TABLE 9
Properties of pilot scale prototypes

| | Protein | | pH | | | | | |
|---|---|---|---|---|---|---|---|---|
| | content | Dry | pea | Gel | Gel | | | |
| | dwb | matter | protein | Strength | Strength | Sodium | Potassium | Solubility |
| Sample | (%) | (%) | extract | (Pa) | Ratio | (ppm) | (ppm) | at pH 7 |
| Control | 82.8 | 92.6 | 7.3 | 1562 | — | 9380 | 3910 | 42.1 |
| Invention | 83.7 | 92.6 | 9.3 | 2508 | 1.6 | 13300 | 7920 | 44.8 |

Besides the products manufactured, different commercial pea protein isolates were evaluated for their performance in powder mix formulations. Below is reported the proteins tested and, for each of these, the advertisement on their intended use.

### Pea Proteins Isolates Advertising Benefits in Functionalities and Sensory in Powder Mix Applications:

PISANE™C9: Pea protein isolate, COSUCRA. “Formulate products in powder form using PISANE™ C9? Nothing is easier thanks to its great solubility and easy reconstitution. Lastly, the unique taste of PISANE™ means you can use it in a wide range of products in powder form.”

PURIS P 875: Pea protein isolate, PURIS. “PURIS P875 is an 80% pea protein designed for multi-serve beverages. This ingredient adds creaminess to non-dairy drinks via unique emulsifying applications.” Protein shake is one of the application targeted.

Pea Proteins Isolates Advertising for Other Applications than Powder Mix:

NUTRALYS® S85 F: Pea protein isolate, ROQUETTE FRERES. “NUTRALYS® pea protein S85F has good solubility, suitable for dairy and dairy-free applications. As an example, in dairy-free products, it is suitable for ready-to-drink milk-like beverages with a protein content up to 3%.”

EMPRO E86Q HV: Pea protein isolate, EMSLAND. Advertised as “High viscous functional protein for texturized proteins”. Also, “Empro® E 86 HV is a high viscous pea protein isolate with excellent emulsifying properties. Empro® E 86 HV is extracted from the yellow pea, a natural, non-allergen and non-GMO material. It shows a balanced amino acid profile which support e.g. Products for weight control as well as sports foods.”

In Table 10 are also reported other functionalities of the proteins, including rheometer viscosity and Turbiscan Stability Index at the Bottom Region (TSIBR) and Turbiscan Stability Index at the Middle Region (TSIMR). Table 2 also reported the average of TSIBR and TSIBM (TSIBMR) and the global Turbiscan Stability Index TSI. Because of the foam is present at the top of every sample, Turbiscan Stability Index at the top Region of the measurement cell are not reported because these are more representative of the foam stability kinetics and less representative of the suspensibility and sedimentation of the protein (even though global TSI is reported for information). Average of Turbiscan Stability Index of Middle Region is more accurate to represent the suspensibility of a protein powder inside a powder shake. The color of the suspension was also determined.

TABLE 10
rheometer viscosity, color and suspensibility index

| | | | NUTRALYS | EMPRO | PISANE | PURIS |
|---|---|---|---|---|---|---|
| | Invention | Control | S85 F | E86 HV | C9 | 875 |
| Rheometer | 0.53 | 0.20 | 0.30 | 0.95 | 0.80 | 0.33 |
| viscosity | | | | | | |
| (Pa · s) | | | | | | |
| L* | 69.16 | 72.91 | 73.84 | 69.12 | 64.89 | 74.48 |
| a* | 1.03 | 3.50 | 2.39 | 4.49 | 6.73 | 4.02 |
| b* | 17.09 | 15.23 | 16.78 | 25.32 | 23.91 | 26.68 |
| TSIBR | 1.42 | 3.81 | 2.26 | 3.24 | 4.07 | 9.88 |
| TSIMR | 1.68 | 1.66 | 0.88 | 3.36 | 11.24 | 16.10 |
| TSIBMR | 1.55 | 2.73 | 1.57 | 3.30 | 7.66 | 12.99 |
| TSI global | 3.08 | 3.94 | 2.80 | 4.36 | 8.67 | 14.19 |

NUTRALYS S85F excepted, the Table shows that the suspensibility of the protein powder was more stable compared to the other samples. PISANE C9 and PURIS 875 were particularly unstable and EMPRO E86 HV was also significantly less stable. The rheometer viscosity of the protein powder was higher than most of the samples, EMPRO E86 HV and Cosucra C9 excepted, which were even higher. It is also demonstrated that the protein powder of the invention, when suspended in water, presented a* and b* values closer to 0 than most of the other samples.

Sensory evaluation was conducted by a qualified panel of twenty persons, all employees of the applicant. The tasting session was organized using white light with blind products presented to the different panelists in a randomized order (3-digit codes).

Regarding the sensory attributes, thickness, creaminess and mouthcoating were evaluated. The different definitions provided to the trained panel were the following:
Thickness: The amount of viscosity of the sample.
Creaminess: The degree of combined qualities of being homogeneous, smooth, and thick texture like double cream.
Mouthcoating: The amount of film left on the mouth surfaces.

The evaluation was conducted as a ranking test between the three proteins by each panelist. Based upon ISO-8587:2011, the ranking methodology was selected “to find if differences exist.” The procedure for presentation of the samples was followed based upon complete block design. “The assessors evaluate the samples presented in random order and place them in rank order on the designated attribute.”

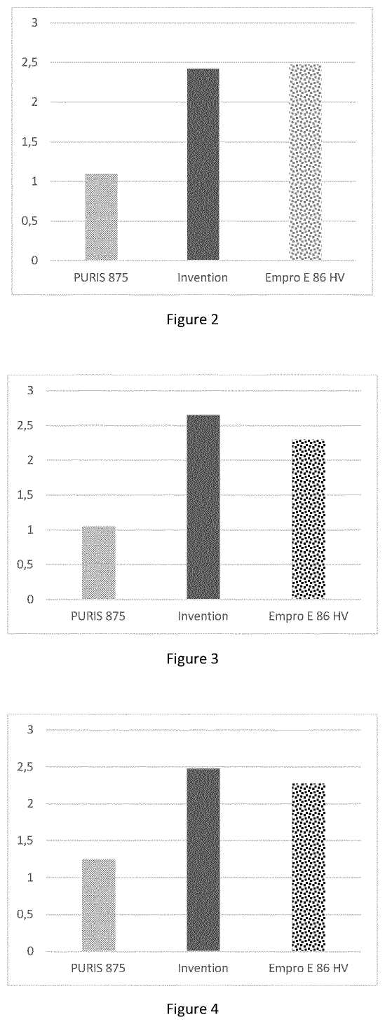

The sensory evaluation of the different protein extracts is reported in FIG. 2 (Thickness), FIG. 3 (Creaminess) and FIG. 4 (Mouthcoating). These results demonstrate, in particular vs. Puris P875 that is advertised as bringing creaminess to the beverages, that the protein of invention can bring higher creaminess (FIG. 2).

### Example 8: Evaluation in Powder Mixes

In this evaluation, two powder mix formulations were tested, one free of hydrocolloids (Table 11) and one comprising hydrocolloids (Table 12)

TABLE 11
recipe without hydrocolloids

| Ingredient | wt. % | Weight (g) |
|---|---|---|
| Control or invention protein isolate | 80.00 | 600.00 |
| NUTRIOSE FM06 (Roquette Frères) | 15.30 | 114.75 |
| Organic Coconut MCT Oil Powder (Pat Ingredients) | 4.70 | 35.25 |

TABLE 12
recipe with hydrocolloids

| Ingredient | wt. % | Weight (g) |
|---|---|---|
| Control protein | 80.00 | 400.00 |
| NUTRIOSE FM06 (Roquette Frères) | 14.75 | 73.75 |
| Organic Coconut MCT Oil Powder (Pat Ingredients) | 4.70 | 23.50 |
| Keltrol SF Xanthan Gum (CP Kelco) | 0.55 | 2.75 |

The powder mix formula comprising control protein without hydrocolloid is powder mix n^{o}1. The powder mix formula comprising control protein with hydrocolloid is powder mix n^{o}2. The powder mix formula comprising invention protein without hydrocolloid is powder mix n^{o}3.

The following process was used:

Dry Blend Preparation: Use the Turbula blender to blend all the dry ingredients at 70 rpm for 5 minutes.

For the preparation of the protein powder suspension, one preparation was done for foamability testing and one other preparation for other analytical testings.
1. Obtain the HealthMaster® Elite Model LWHME blender (for foamability testing) and shaker bottles (for the remainder of analytical testing).
2. Combine 354 g (89.85% of the final solution) of purified/filtered refrigerated water and 40 g (10.15% of the final solution) of powdered mix in the blender or shaker bottle. Making 394 g of total solution (6.5% total protein content in solution).
3. Blender: Blend on the Speed 1 Setting (21,750 RPM) for 10 seconds for foamability testing.
4. Shaker Bottle: Shake the sample consistently for 15 seconds until fully dispersed for the other testings (rheometer viscosity, suspensibility and sensory evaluation).

Regarding the sensory attributes, thickness, creaminess and mouthcoating were evaluated. Sensory evaluation of the powder mixes of the invention (n^{o}3) was investigated in comparison with control powder mix n^{o}1 in a first session. Sensory evaluation of the powder mixes of the invention (n^{o}3) was investigated in comparison with powder mix n^{o}2 that did comprise hydrocolloids and the control protein.

The two sensory evaluations were conducted by a qualified panel of seventeen persons, all employees of the applicant. Each tasting session was organized on a different day. It was done using white light with blind products presented to the different panelists in a randomized order (3-digit codes).

The evaluation was conducted as a pairwise comparison test of the two protein mix by each panelist. Based upon ISO-8587:2011, the methodology was selected “to find if differences exist.” The procedure for presentation of the samples was followed based upon complete block design. “The assessors evaluate the samples presented in random order and place them in rank order on the designated attribute.”

Powder mix of the invention had more body than the control (n^{o}2): it was thicker (p-value <0.0001), creamier (p-value <0.0001), and had more mouthcoating (p-value <0.0023). The p-values demonstrate how significant the difference was perceived by the trained panel: these three p-values reflect a significant difference in perception by the trained panel.

Powder mix of the invention did not show any significant differences in the mouthfeel/texture aspect with the powder mix n^{o}3 that comprises hydrocolloids and control protein: it was equally thick (p-value >0.9999), equally creamy (p-value=0.8036), and had equal mouthcoating (p-value >0.9999). These three p-values reflect no significant difference in perception by the trained panel.

Further, different commercial powder mixes of the market were evaluated and compared to these 3 formulations in regard to viscosity, foamability and suspensibility. For these market samples, the quantities of the powder mix to be suspended in water were selected so that the beverages reach same protein content than above (6.5% total protein content in solution). Foamability, viscosity and suspensibility were determined and are reported in Table 13.

TABLE 13
Foamability, viscosity and suspensibility

| | | | 3 | | | | | |
|---|---|---|---|---|---|---|---|---|
| Powder | | | (Inven- | | | | | |
| mix | 1 | 2 | tion) | 4 | 5 | 6 | 7 | 8 |
| RVA | 43 | 75 | 86 | 29 | 73 | 48 | 51 | 25 |
| viscosity | | | | | | | | |
| (cP) | | | | | | | | |
| TSIMR | 2.69 | 3.18 | 1.96 | 7.31 | 5.96 | 7.00 | 6.86 | 10.85 |
| Foamability | 21.81 | 12.43 | 7.32 | 27.14 | 13.73 | 15.85 | 22.39 | 19.62 |
| (% vol) | | | | | | | | |

1: control powder mix free of hydrocolloids - 2: control powder mix with hydrocolloids - 3: powder mix of the invention - 4: Pepsico EVOLVE Vanilla Bean Plant-Based Protein Powder - 5: Orgain Sport Plant-Based Protein Powder Vanilla Flavored - 6: Orgain Standard Plant-Based Protein Powder Vanilla Flavored - 7: Vega Premium Sport Protein Powder Vanilla Flavored - 8: Garden of Life Organic Sports Vanilla Flavored Protein Powder

It has to be noted that, except Garden of life powder mix, all the commercial powder mixes comprised hydrocolloids, such as xanthan gum, acacia gum, guar gum. The powder mix of the invention had the highest viscosity whereas it does not comprise any hydrocolloid. Because with the thickening, creaminess and mouthfeel perception benefits, the pea protein of the invention can replace hydrocolloids in this application. It is also demonstrated that it can also replace emulsifiers by seeing how stable the powder mix is in solution, as shown by TSIMR values. One other advantage of the protein powder of the invention is that it can provide a powder mix beverage that has low foaming. All these attributes confirm the advantage of this protein isolate in powder mix applications.

### Example 9: Evaluation in Other Powder Mix Formulas

In this evaluation, one other powder mix formulation was used for testing five different proteins including protein of the invention and of the control. Recipe is reported in Table 14.

TABLE 14
composition of the powder mix

| Ingredients | wt % |
|---|---|
| Protein | 88.500 |
| NUTRIOSE ® FM06 soluble fiber | 10.586 |
| Lecithin sunflower | 0.700 |
| Xanthan gum | 0.128 |
| Sucralose | 0.043 |
| Acesulfam K | 0.043 |
| Total | 100.000 |

The different powder mixes were prepared in a similar manner. The powder mix beverage was prepared by putting 40 g of powder mix in a protein shaker with 325 ml of Evian water and was vigorously shaken 30 seconds. The beverage is poured in a test tube. The foam volume in mL was measured and reported after 15 minutes.

In Table 15 are reported the results obtained concerning RVA viscosity and foaming for the different powder mix beverages.

TABLE 15
attributes of the different powder mixes

| Protein of the | | Volume of foam |
|---|---|---|
| powder mix | RVA viscosity (cP) | after 15 min (mL) |
| Invention | 334 | 20 |
| Control | 73 | 100 |
| NUTRALYS S85 F | 166 | 50 |
| PISANE C9 | 133 | 33 |
| PURIS 875 | 68 | 103 |

This evaluation shows that the protein of the invention can bring increased viscosity, which can highly contribute to the mouthfeel of the beverage. Another advantage is the low foaming observed. Moreover, high levels of sedimentation were observed for powder mix beverages comprising PISANE C9 or PURIS 875, whereas it is not the case with the protein of the invention which provides a much more suspensible protein powder mix. These results in this alternative powder mix formulation, with higher protein concentration in the beverage, confirmed results obtained with powder mixes of the Example 8, which demonstrates the versatility in usage of the protein of the invention.

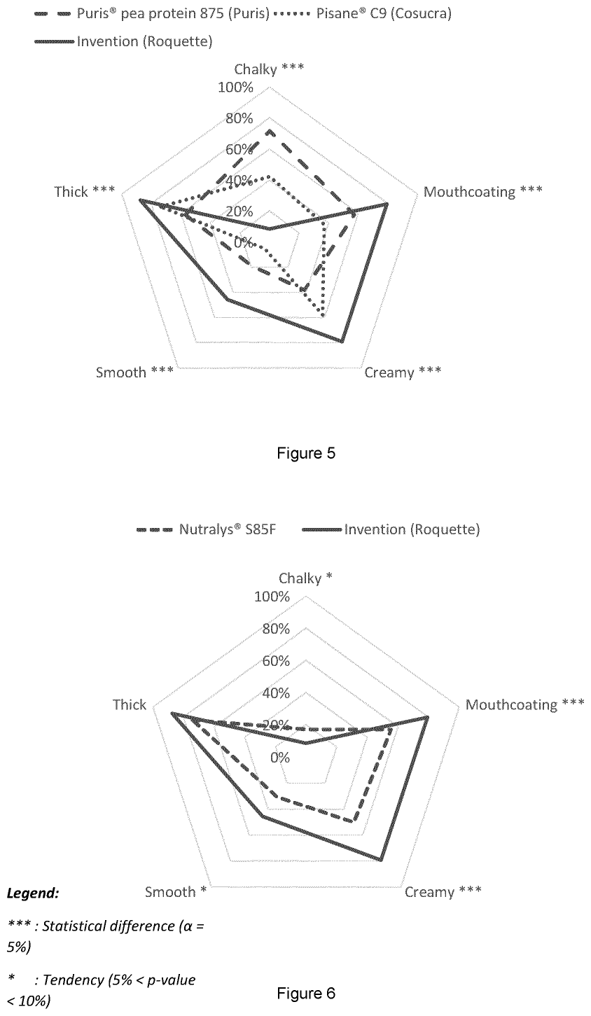

The sensory evaluation of the texture of the powder mix was also conducted for these powder mix beverages. Results are reported in FIGS. 5 and 6.

Besides mouthcoating, thickness and creaminess, 2 other texture attributes were also determined during this session: smoothness and chalkiness. The definitions of these 2 other attributes were provided to the trained panel:
Smoothness: No particles perceived in mouth during and after the tasting, like milk or water.
Chalkiness: Particles perceived in mouth during and after the tasting, like wheat starch in water (10%).

The powder mix beverage was stored and served at room temperature before tasting session.

The test conditions were the following:
Sensory lab (ISO 8589:2007)
White light
Blind products (3-digit codes) with a randomized order
≥20 qualified or expert panelists
Sensory method: CATA (Check-All-That-Apply; ISO 5492:2008, 4.24)
5 texture attributes (chalkiness, mouthcoating, creaminess, smoothness, thickness)·
Statistical analysis: Chi² test+Marascuilo procedure

This method is a semi-quantitative method. The powder mix of the invention is the least chalky and brings the most mouthcoating, creamy, smooth and thick texture. Puris® based powder mix is the chalkiest, the least creamy and the least thick. Pisane® C9 based powder mix is the least mouthcoating and has the lowest smoothness. Compared to NUTRALYS S85 F based powder mix, the invention is bringing much more mouthcoating and creaminess textures and tends to be less chalky and smoother.

### Discussion on Results Obtained in Examples 7 to 9 Concerning Powder Preparation for Beverages Application

All these results demonstrate the interest of the leguminous protein extract of the invention in powder preparation for beverages. Indeed, these proteins did allow the production of stable powder mix beverages, with no addition of emulsifiers or hydrocolloids (Example 8). Moreover, the texture of the powder mix of the invention, that was free of any hydrocolloids, was felt much creamier than the powder mix beverage of same recipe but with control protein instead. It was considered by the trained panel to have no significant difference in the creaminess in comparison to a powder mix comprising the control pea protein and hydrocolloids (xanthan gum). The results confirmed the evaluation done in Example 7 in which it was demonstrated that the protein extract used in the powder mix of the invention did present high creaminess. It is particularly surprising in that the protein isolates useful to the invention did present functionalities very different from the proteins that are advertised to provide benefits in powder mix applications (PISANE C9 and PURIS P875). It is also surprising to observe that, whereas the protein of the invention has lower rheometer viscosity than EMPRO E86 HV pea protein, it does not negatively impact the creaminess. Example 9 confirmed improvements in a powder mix beverage thanks to the protein useful to the invention in comparison with other proteins. The benefits included improved suspensibility and lower foaming of the powder mix beverage. In the powder mix beverage, the improved texture was also found smoother and having lower chalkiness.

1. A leguminous acid-gelling protein extract having a protein content, expressed on dry weight basis of the extract, of 75% or higher and a storage modulus of at least 1800 Pa, advantageously at least 2000 Pa when determined using TEST A, preferably at least 2500 Pa.

2. The leguminous acid-gelling protein extract of claim 1, wherein the leguminous acid-gelling protein has a firmness of at least 100 g when determined using TEST B, advantageously at least 125 g, preferably at least 150 g.

3. The leguminous acid-gelling protein extract of claim 1, comprising sodium Na and potassium Kin a molar ratio (Na/K) ranging from 10:90 to 90:10.

4. The leguminous acid-gelling protein extract of claim 1, wherein the leguminous acid-gelling protein extract is a pea acid-gelling protein extract.

5. The leguminous acid-gelling protein extract of claim 1, wherein the protein is denaturated.

6. The Leguminous acid-gelling protein extract of claim 1, wherein the pH of the leguminous protein extract ranges from 8.0 to 9.5, for example from 8.5 to 9.4.

7. The leguminous acid-gelling protein extract of claim 1, wherein the pH of the leguminous protein extract ranges from 5.0 to 8.0, for example from 6.0 to 8.0.

8. The leguminous acid-gelling protein extract of claim 1, wherein the leguminous acid-gelling protein extract has a dry matter ranging from 90 to 100%.

9. A method of preparation of an acid-gelling leguminous protein extract according to claim 1, comprising the following steps:
i) preparing an aqueous solution of a leguminous protein extract;
ii) adjusting the pH of the solution of step i) to a value comprised in the range of from 8.0 to 9.5;
iii) heating the solution of step ii) at a temperature ranging from 80° C. to 160° C. during a time sufficient to increase the storage modulus of the leguminous protein extract;
iv) optionally adjusting the pH of the solution of step iii) to a value comprised in the range of from 5.0 to 8.0;
v) recovering the obtained acid-gelling leguminous protein extract; and
vi) optionally drying the obtained acid-gelling protein extract.

10. The method of preparation of claim 9, wherein the leguminous protein extract provided in step i) is prepared by a process comprising the steps of:
providing leguminous plant seeds containing a leguminous protein
milling said leguminous plant seeds and suspending the obtained flour in an extracting liquid;
recovering the leguminous protein from the suspension, thereby obtaining a protein leguminous extract.

11. The method of preparation of claim 9, wherein the time of the heating step iii) ranges from 0.1 second to 10 minutes, preferably from 0.1 s to 1 minute, most preferably from 0.5 s to 50 s, for example from 1 s to 40 s or 2 s to 30 s or 5 to 20 S.

12. The method of preparation of any claim 9, wherein the temperature during the heating step iii) ranges from 120 to 150° C.

13. The method of preparation of claim 9, the heating step iii) is performed during a sufficient time to reach a storage modulus of at least 1800 Pa when determined using TEST A.

14. The method of preparation of claim 9, wherein step ii) is performed by adding to the solution of step i), a mixture of sodium hydroxide and potassium hydroxide, preferably in a (NaOH/KOH) molar ratio ranging from 10:90 to 90:10.

15. A use of the leguminous acid-gelling protein extract of claim 1 in acid-gelling food products.

16. An acid-gelling food products comprising a leguminous acid-gelling protein extract of claim 1.
